(19) United States
(12) Patent Application Publication
(10) Pub. No.: US 2016/0167478 A1
(43) Pub. Date: Jun. 16, 2016

(54) AIR CONDITIONING SYSTEM FOR MOTOR VEHICLES

(71) Applicant: HALLAVISTEON CLIMATE CONTROL CORP., Daejeon (KR)

(72) Inventors: Dae Woong Lee, Daejeon (KR); Chang Hyun Baek, Daejeon (KR); Seo Jun Yoon, Daejeon (KR); Tae Wan Kim, Daejeon (KR); Jang Soon Shin, Daejeon (KR); Woo Youl Jung, Daejeon (KR); Hong Hee Jeong, Daejeon (KR); Jin Hyoung Kim, Daejeon (KR); Hyup Kim, Daejeon (KR)

(21) Appl. No.: 14/649,995

(22) PCT Filed: May 26, 2014
(86) PCT No.: PCT/KR2014/004662

§ 371 Date: Jun. 5, 2015

(30) Foreign Application Priority Data
May 27, 2013 (KR) 10-2013-0059826
Aug. 19, 2013 (KR) 10-2013-0097616
Sep. 5, 2013 (KR) 10-2013-0106451

(51) Int. Cl. B60H 1/00; B60H 1/24

(52) U.S. Cl. CPC B60H 1/00742; B60H 1/244; B60H 1/243; B60H 1/00735; B60H 1/00828

(57) ABSTRACT

An air conditioning system for motor vehicles includes a front seat air conditioner installed in a front seat region of a vehicle room, and an auxiliary blower configured to draw an air existing in the vehicle room and blow the air into the vehicle room such that a cold air or a hot air supplied to the front seat region flows toward a rear seat region. The system further includes a rear seat air conditioner installed within one of vehicle sidewalls which define the rear seat region. The rear seat air conditioner configured to supply a cold air or a hot air to cool or heat the rear seat region. The system further includes a control unit for controlling the auxiliary blower.

### FIELD OF THE INVENTION

The present invention relates to an air conditioning system for motor vehicles and, more particularly, to an air conditioning system for motor vehicles which can reduce a temperature difference between front and rear seat regions by improving the air flowability within a vehicle room and which can maintain a uniform temperature distribution with no temperature difference between front and rear seat regions by allowing a cold air or a hot air to be evenly and uniformly blown toward individual seats of a rear seat region.

### BACKGROUND OF THE INVENTION

In case of a vehicle having a wide vehicle room, e.g., a large-size passenger vehicle or a recreational vehicle, the cooling or heating efficiency of a vehicle room is reduced if only one air conditioner 10 is installed in front of a driver's seat as shown in FIG. 1. In particular, the cooling or heating efficiency is significantly reduced in a rear seat region.

In view of this, as shown in FIG. 2, in addition to a front seat air conditioner 10 installed in front of a driver's seat, a rear seat air conditioner 20 may be additionally installed in a rear region of a vehicle room. Thus, the front and rear regions of the vehicle room are cooled or heated independently of each other, thereby increasing the cooling or heating efficiency of a front seat region and a rear seat region.

Typically, as shown in FIG. 2, the rear seat air conditioner 20 is installed within one of vehicle sidewalls 22 which define the rear seat region. More specifically, as shown in FIG. 3, the rear seat air conditioner 20 is installed within one of vehicle sidewalls 22 which exist above wheel housings 24. The rear seat air conditioner 20 thus installed is configured to supply a cold air or a hot air to the rear seat region of a vehicle room.

In case where there is installed only the front seat air conditioner 10, the cooling or heating efficiency of the vehicle room is reduced. This poses a problem in that it is difficult to satisfy all the passengers seated on the respective seats.

In case where the front seat air conditioner 10 and the rear seat air conditioner 20 are installed, there is a drawback in that the cost is increased due to the additional installation of the rear seat air conditioner 20.

When additionally installing the rear seat air conditioner 20, it is necessary to provide a separate installation space for the accommodation of the rear seat air conditioner 20. For that reason, the sidewalls 22 of a vehicle body should be designed to have an increased size.

Furthermore, additional power should be used in order to drive the rear seat air conditioner 20. This leads to an increased consumption of energy, which results in a reduction of fuel efficiency of a motor vehicle.

Moreover, the rear seat air conditioner 20 has a shortcoming in that a noise is generated during the operation thereof. This leads to a problem of reduced comfort. In addition, it is likely that the rear seat air conditioner 20 is operated even when the rear seat region is empty or when the blower (not shown) of the front seat air conditioner 10 is operated at a maximum level. In that case, the rear seat air conditioner 20 unnecessarily generates a noise, consequently impairing the comfort of the vehicle room.

In addition, despite the installation of the rear seat air conditioner 20, a temperature difference may be generated between the seats of the rear seat region. This poses a problem in that the comfort of the vehicle room is significantly impaired.

Since the rear seat air conditioner 20 is installed in only one of the vehicle sidewalls 22 which define the rear seat region, as shown in FIG. 2, the rear seat region has an area (A) to which a cold air or a hot air is smoothly blown and an area (B) to which a cold air or a hot air is not smoothly supplied. Thus a temperature difference is generated between the areas (A and B). This poses a problem in that the comfort is significantly reduced in the rear seat region.

Specifically, a cold air or a hot air is smoothly blown from the rear seat air conditioner 20 to the area (A) existing at the opposite side from the rear seat air conditioner 20. In contrast, a cold air or a hot air is not smoothly supplied from the rear seat air conditioner 20 to the area (B) existing near the rear seat air conditioner 20. Thus, there is a problem in that a temperature difference is generated between the areas (A and B).

For that reason, as shown in FIG. 4, a temperature difference D between the seats of the rear seat region grows larger. Thus, the cooling or heating efficiency is reduced in the rear seat region. As a result, the comfort is significantly impaired in the rear seat region.

### SUMMARY OF THE INVENTION

In view of the above-noted problems, it is an object of the present invention to provide an air conditioning system for motor vehicles which can allow a cold air or a hot air to smoothly flow from a front seat air conditioner toward a rear seat region with no use of a rear seat air conditioner by improving the flowability of the cold air or the hot air within a vehicle room.

Another object of the present invention is to provide an air conditioning system for motor vehicles capable of improving the comfort within a vehicle room with no likelihood of cost increase, fuel efficiency reduction and noise generation which may otherwise be generated due to installation of a rear seat air conditioner.

A further object of the present invention is to provide an air conditioning system for motor vehicles which can, in case of installing a rear seat air conditioner, increase the stirring efficiency of a cold air or a hot air supplied from the rear seat air conditioner to a rear seat region and which can allow a cold air or a hot air to be evenly and uniformly blown from the rear seat air conditioner toward individual seats of a rear seat region.

A still further object of the present invention is to provide an air conditioning system for motor vehicles which can maintain a uniform temperature distribution with no temperature difference between individual seats of a rear seat region.

A yet still further object of the present invention is to provide an air conditioning system for motor vehicles capable of improving the cooling or heating efficiency of a rear seat region and consequently enhancing the comfort in the rear seat region.

With the above objects in mind, the present invention provides an air conditioning system for motor vehicles, including: a front seat air conditioner installed in a front seat region of a vehicle room; and an auxiliary blower configured to draw an air exiting in the vehicle room and blow the air into the vehicle room such that a cold air or a hot air supplied to the front seat region flows toward a rear seat region.

Preferably, the auxiliary blower may be installed in a rear covering shelf between a rear seat and a rear glass and may be configured to draw an air existing in the rear seat region and blow the air toward the front seat region along a roof.

Preferably, the air conditioning system may further include a rear seat air conditioner installed within one of vehicle sidewalls which define the rear seat region, the rear seat air conditioner configured to supply a cold air or a hot air to cool or heat the rear seat region. The auxiliary blower may be configured to blow the air toward the rear seat region to stir the cold air or the hot air supplied from the rear seat air conditioner into the rear seat region.

Preferably, the auxiliary blower may be installed in the other sidewall opposite to the rear seat air conditioner. The auxiliary blower may be configured to blow the air toward a dead zone where the cold air or the hot air is hardly supplied from the rear seat air conditioner.

Preferably, the air conditioning system may further include a control unit for controlling the auxiliary blower, the control unit configured to turn off the auxiliary blower when a passenger does not exist in the rear seat region and to turn on the auxiliary blower when a passenger exists in the rear seat region.

Preferably, the control unit may be configured to turn off the auxiliary blower if a main blower of the front seat air conditioner is operated at a maximum rotation speed level.

According to the air conditioning system of the present invention, the auxiliary blower is installed in the rear seat region to improve the flowability of an air within the vehicle room. This enables a cold air or a hot air to smoothly flow from the front seat air conditioner to the rear seat region without having to use a rear seat air conditioner.

It is therefore possible to improve the comfort within the vehicle room with no likelihood of cost increase, fuel efficiency reduction and noise generation which may otherwise be generated due to installation of a rear seat air conditioner.

In case of installing a rear seat air conditioner, it is possible to increase the stirring efficiency of a cold air or a hot air supplied from the rear seat air conditioner to the rear seat region. Thus, a cold air or a hot air can be evenly and uniformly blown from the rear seat air conditioner toward the individual seats of the rear seat region.

Furthermore, it is possible to maintain a uniform temperature distribution with no temperature difference between the individual seats of the rear seat region.

In addition, it is possible to improve the cooling or heating efficiency of the rear seat region and to significantly enhance the comfort in the rear seat region.

### BRIEF DESCRIPTION OF THE DRAWINGS

The above and other objects and features of the present invention will become apparent from the following description of preferred embodiments given in conjunction with the accompanying drawings.

FIG. 1 is a view showing the configuration of a conventional air conditioning system for passenger vehicles.

FIG. 2 is a view the configuration of a conventional air conditioning system for recreational vehicles.

FIG. 3 is a perspective view showing a state in which a conventional rear seat air conditioner is installed in a motor vehicle.

FIG. 4 is graph representing a temperature change in individual seats of a rear seat region during the operation of the conventional rear seat air conditioner.

FIG. 5 is a view showing an air conditioning system for motor vehicles according to a first embodiment of the present invention.

FIG. 6 is a view showing the air conditioning system for motor vehicles according to the first embodiment of the present invention, with an auxiliary blower indicated on an enlarged scale.

FIG. 7 is a flowchart showing an operation example of the air conditioning system for motor vehicles according to the first embodiment of the present invention.

FIG. 8 is a graph showing an operational effect of the air conditioning system for motor vehicles according to the first embodiment of the present invention, which indicates a temperature change in a rear seat region depending on the installation and non-installation of an auxiliary blower.

FIG. 9 is a graph showing an operational effect of the air conditioning system for motor vehicles according to the first embodiment of the present invention, which indicates a change of a temperature difference between a passenger head side and a passenger leg side in a rear seat region depending on the installation and non-installation of an auxiliary blower.

FIG. 10 is a view showing an air conditioning system for motor vehicles according to a second embodiment of the present invention.

FIGS. 11, 12 and 13 are views showing different modifications of the air conditioning system for motor vehicles according to the second embodiment of the present invention.

FIG. 14 is a graph showing an operational effect of the air conditioning system for motor vehicles according to the second embodiment of the present invention, which indicates a temperature change in individual seats of a rear seat region.

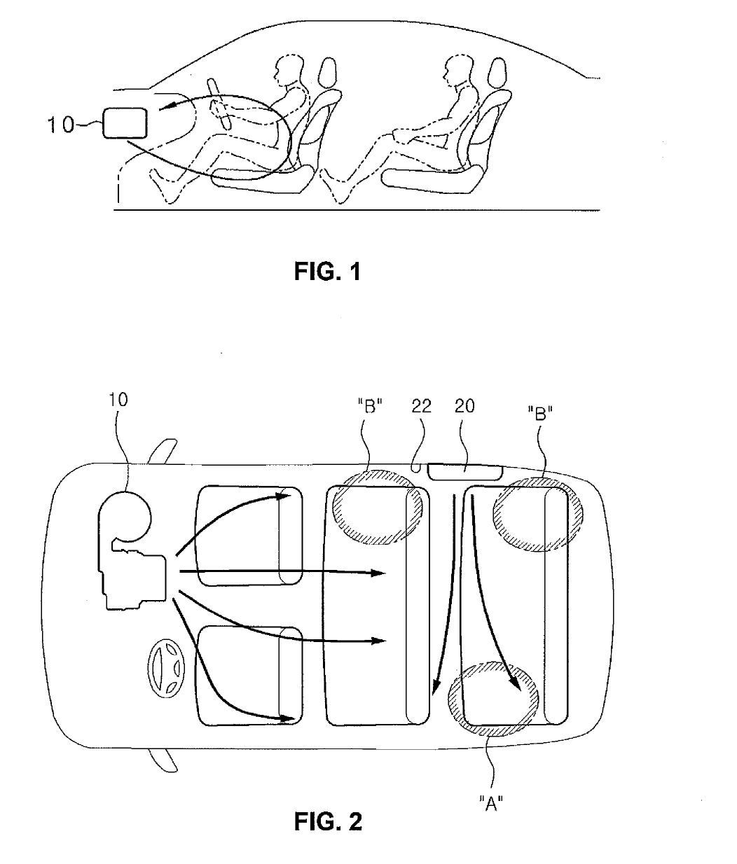

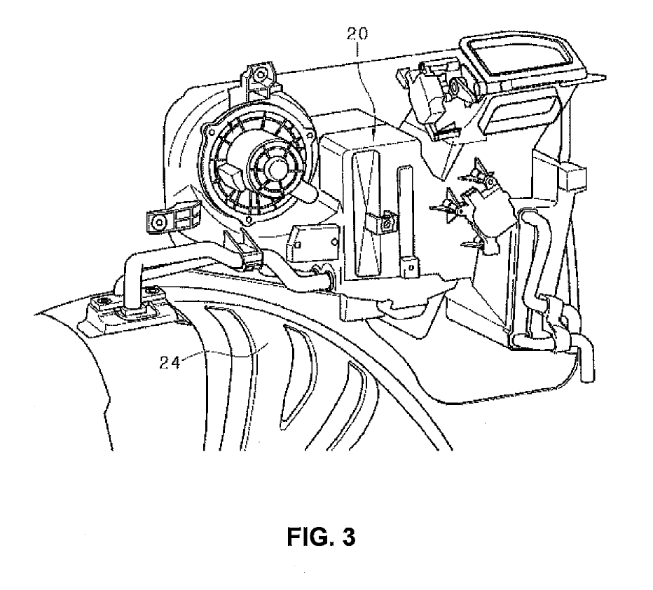

### DETAILED DESCRIPTION OF THE PREFERRED EMBODIMENTS

Some preferred embodiments of an air conditioning system for motor vehicles according to the present invention will now be described in detail with reference to the accompanying drawings.

### First Embodiment

First, an air conditioning system for motor vehicles including only a front seat air conditioner will be described as a first embodiment. Prior to describing features of the first embodiment, a front seat air conditioner 100 will be briefly described with reference to FIG. 5.

The front seat air conditioner 100 includes an evaporator (not shown) for cooling an air, a heater (not shown) for heating an air, and a blower (not shown) for blowing a cold air or a hot air cooled or heated by the evaporator or the heater into a vehicle room.

The front seat air conditioner 100 is configured to supply the cold air or the hot air toward a front seat region X of a vehicle room, thereby cooling or heating the front seat region X of the vehicle room.

In general, the cold air or the hot air supplied to the front seat region X of the vehicle room flows toward a rear seat region Y of the vehicle room, eventually cooling or heating the rear seat region Y of the vehicle room.

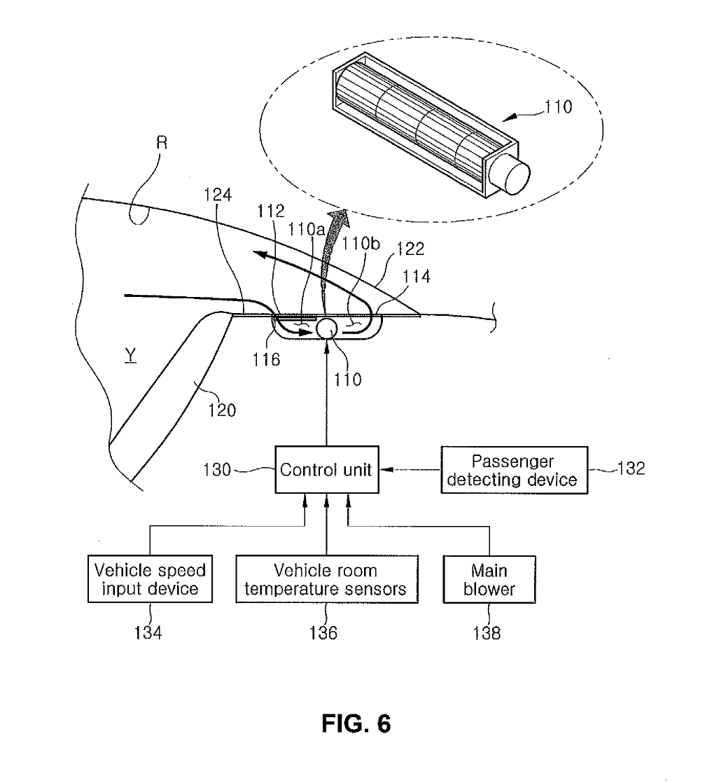

Next, certain features of the first embodiment will be described in detail with reference to FIGS. 5 and 6.

The air conditioning system according to the first embodiment further includes an auxiliary blower 110 installed in a rear covering shelf 124 existing between rear seats 120 and a rear glass 122.

The auxiliary blower 110 is configured to suck an air existing in the rear seat region Y and to blow the sucked air toward a roof R which defines the vehicle room. Thus, the cold air or the hot air supplied from the front seat air conditioner 100 toward the rear seat region Y can flow along the roof R and can move toward the front seat region X. This makes it possible to improve the efficiency of circulation of the cold air or the hot air between the rear seat region Y and the front seat region X. As a result, the cold air or the hot air supplied from the front seat air conditioner 100 can efficiently circulate through the front seat region X and the rear seat region Y. This makes it possible to significantly improve the cooling or heating efficiency of the vehicle room.

The auxiliary blower 110 is preferably embedded within the rear covering shelf 124 such that the auxiliary blower 110 is not visible to the eyes of a passenger. Furthermore, the auxiliary blower 110 includes an air intake port 110a which faces the rear seat region Y and an air discharge port 110b which faces the rear glass 122. An intake grill 112 is installed in the air intake port 110a while a discharge grill 114 is installed in the air discharge port 110b.

A filter 116 is installed in the intake grill 112 of the auxiliary blower 110. The filter 116 can remove dust or the like from the air sucked into the auxiliary blower 110. This makes it possible to improve the durability of the auxiliary blower 110 and to purify the air existing within the vehicle room.

As the auxiliary blower 110, it is preferable to use a cross flow fan which is superior in wind direction characteristics and diffusion characteristics. It is preferred that one auxiliary blower is installed in a typical passenger vehicle while two or more auxiliary blowers are installed in a large-size vehicle such as a recreational vehicle or the like.

Referring again to FIG. 6, the air conditioning system according to the first embodiment further includes a control unit 130. The control unit 130 is configured to control the auxiliary blower 110 depending vehicle conditions. The control unit 130 is connected to devices capable of detecting vehicle conditions, for example, a passenger detecting device 132, a vehicle speed input device 134, vehicle room temperature sensors 136 and a main blower 138 of the front seat air conditioner 100.

The control unit 130 turns on the auxiliary blower 110 only when the existence of a passenger in the rear seat region Y of the vehicle room is detected by the passenger detecting device 132. Thus, the auxiliary blower 110 is operated when a passenger exists in the rear seat region Y. This prevents an unnecessary operation of the auxiliary blower 110, thereby reducing power consumption and improving fuel efficiency.

In this regard, the passenger detecting device 132 is configured by a seat pressure sensor, an infrared sensor, a camera or the like. The passenger detecting device 132 detects the existence of a passenger by processing data inputted from the seat pressure sensor, the infrared sensor, the camera or the like.

If a vehicle travel speed is inputted from the vehicle speed input device 134, the control unit 130 controls a rotation speed level of the auxiliary blower 110 in a corresponding relationship with the vehicle travel speed.

More specifically, if the vehicle travel speed inputted from the vehicle speed input device 134 is a high vehicle speed, the control unit 130 operates the auxiliary blower 110 at a maximum rotation speed level. If the inputted vehicle travel speed is not a high vehicle speed, namely if the inputted vehicle travel speed is a low vehicle speed, the control unit 130 variably controls the rotation speed level of the auxiliary blower 110 depending on the vehicle travel speed, thereby reducing a noise generated by the operation of the auxiliary blower 110. This makes it possible to enhance the comfort felt by a passenger.

As an example, if the vehicle travel speed is a high vehicle speed, a vehicle travel noise becomes larger. For that reason, even if the auxiliary blower 110 is operated at a maximum rotation speed level, a passenger does not feel unpleasant. If the vehicle travel speed is a low vehicle speed, a vehicle travel noise becomes smaller. In this case, the unpleasantness felt by a passenger due to the operation noise of the auxiliary blower 110 can be reduced by lowering the rotation speed level of the auxiliary blower 110.

In this regard, a value of a high vehicle speed is previously stored in the control unit 130. An upper limit value of the rotation speed level of the auxiliary blower 110 is limited on the basis of the value of the high vehicle speed stored in the control unit 130. The value of the high vehicle speed is not fixed but may be changed depending on the kind of motor vehicles.

In addition, the control unit 130 stores different values of the rotation speed levels of the auxiliary blower 110 associated with the respective vehicle travel speeds. During the low vehicle speed, the control unit 130 variably controls the rotation speed level of the auxiliary blower 110 depending on the vehicle travel speed. Preferably, the control unit 130 stores the values of the rotation speed levels of the auxiliary blower 110 such that the values become smaller as the vehicle travel speed grows lower. This is because the vehicle travel noise becomes smaller as the vehicle travel speed grows lower. The rotation speed level of the auxiliary blower 110 is set such that the auxiliary blower 110 generates a reduced noise as the vehicle travel noise becomes smaller.

Furthermore, if vehicle room temperature data are inputted from the vehicle room temperature sensors 136, the control unit 130 calculates a temperature difference between the temperatures of the respective regions of the vehicle room. The control unit 130 is configured to set the rotation speed level of the auxiliary blower 110 in view of the temperature difference thus calculated.

More specifically, if temperature data on the temperature of the well-cooled or heated front seat region X and the temperature of the illumination light-cooled or heated rear seat region Y are inputted from the vehicle room temperature sensors 136, the control unit 130 calculates a temperature difference between the inputted temperature data and variably controls the rotation speed level of the auxiliary blower 110 depending on the calculated temperature difference. Preferably, one of the vehicle room temperature sensors 136 is installed in the front seat region X of the vehicle room while another vehicle room temperature sensor 136 is installed in the rear seat region Y where cooling or heating is weak. In addition, different rotation speed levels of the auxiliary blower 110 corresponding to different vehicle room temperature differences are previously stored in the control unit 130.

Preferably, the rotation speed levels of the auxiliary blower 110 corresponding to the vehicle room temperature differences, which are stored in the control unit 130, are set such that the rotation speed levels of the auxiliary blower 110 become higher as the vehicle room temperature differences grow larger.

With this configuration, the rotation speed level of the auxiliary blower 110 becomes higher as the vehicle room temperature difference grows larger. This makes it possible to increase the stirring efficiency of the air existing in the front seat region X and the rear seat region Y. As s result, it is possible to increase the cooling or heating efficiency of the vehicle room.

In addition, the control unit 130 is configured to control the auxiliary blower 110 depending on the rotation speed level of the main blower 138. For example, if the main blower 138 is operated at the maximum rotation speed level, the air sufficiently flows through the rear seat region Y as well as the front seat region X. In this case, the auxiliary blower 110 is turned off to prevent an unnecessary operation of the auxiliary blower 110. This makes it possible to reduce power consumption, thereby improving fuel efficiency.

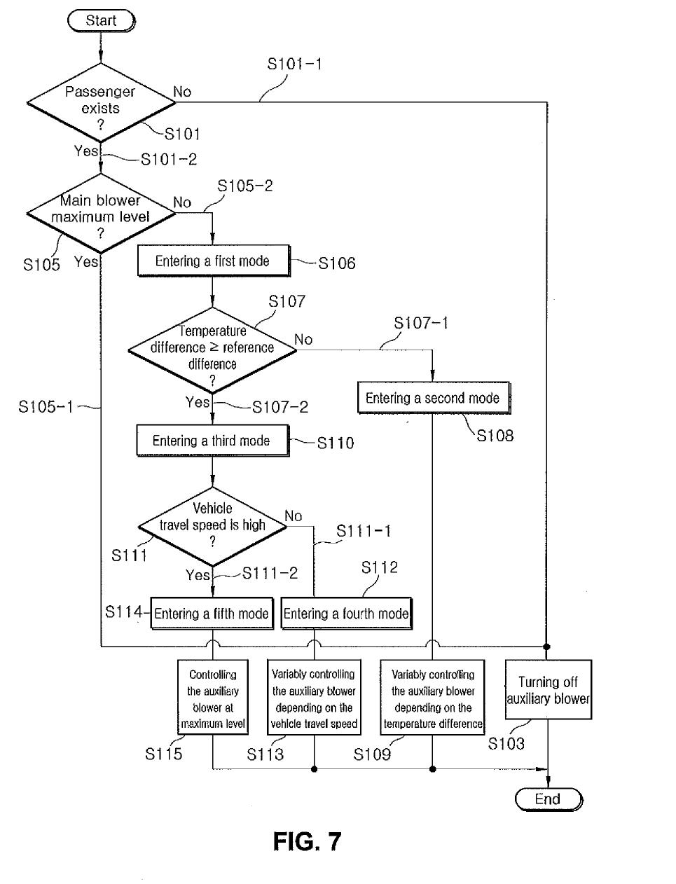

Next, an operation example of the air conditioning system according to the first embodiment will be described with reference to FIG. 7.

First, determination is made as to whether a passenger exists in the rear seat region Y of the vehicle room (S101). If it is determined that a passenger does not exist in the rear seat region Y (S101-1), there is no need to operate the auxiliary blower 110. In this case, the auxiliary blower 110 is turned off (3103). This makes it possible to prevent unnecessary consumption of energy and to improve fuel efficiency of a motor vehicle.

On the other hand, if it is determined that a passenger exists in the rear seat region Y (S101-2), determination is made as to whether the main blower 138 of the front seat air conditioner 100 is operated at a maximum rotation speed level (S105). If it is determined that the main blower 138 is operated at a maximum rotation speed level (S105-1), it is recognized that a cold air or a hot air smoothly flows from the front seat air conditioner 100 to the rear seat region Y. In this case, there is no need to operate the auxiliary blower 110. Accordingly, the auxiliary blower 110 is turned off (S103).

On the other hand, if it is determined that the main blower 138 is not operated at a maximum rotation speed level (S105-2), namely if the rotation speed level of the main blower 138 is lower than the maximum rotation speed level, the control unit 130 enters a first mode (S106).

Then, determination is made as to whether a temperature difference between the front seat region X and the rear seat region Y of the vehicle room is equal to or larger than a predetermined reference temperature difference (S107).

If it is determined that the temperature difference is not equal to or larger than the predetermined reference temperature difference (S107-1), namely if the temperature difference is smaller than the predetermined reference temperature difference, the control unit 130 enters a second mode (S108). Then, the control unit 130 variably controls the rotation speed level of the auxiliary blower 110 depending on the temperature difference between the front seat region X and the rear seat region Y (S109). As a result, the control unit 130 actively controls the rotation speed level of the auxiliary blower 110 and actively controls the flowability of a cold air or a hot air in the front seat region X and the rear seat region Y, thereby reducing the temperature difference between the front seat region X and the rear seat region Y. This makes it possible to increase the cooling or heating efficiency of the front seat region X and the rear seat region Y.

On the other hand, if it is determined that the temperature difference is equal to or larger than the predetermined reference temperature difference (S107-2), the control unit 130 enters a third mode (S110). Then, determination is made as to whether the vehicle travel speed is a high vehicle speed equal to or higher than a predetermined reference vehicle speed (S111).

If it is determined that the vehicle travel speed is not the high vehicle speed equal to or higher than the predetermined reference vehicle speed (S111-1), namely if the vehicle travel speed is a low vehicle speed, the control unit 130 enters a fourth mode (S112). Then, the control unit 130 variably controls the rotation speed level of the auxiliary blower 110 depending on the vehicle travel speed (S113). As a result, the control unit 130 actively controls the rotation speed level of the auxiliary blower 110 depending on the vehicle travel speed such that a large noise should not be generated from the auxiliary blower 110. In this way, it is possible to improve the flowability of a cold air or a hot air between the front seat region X and the rear seat region Y and to prevent reduction of the pleasantness in the vehicle room, which may otherwise be caused by the blower noise.

On the other hand, if it is determined that the vehicle travel speed is the high vehicle speed equal to or higher than the predetermined reference vehicle speed (S111-2), the control unit 130 enters a fifth mode (S114). Then, the control unit 130 controls the rotation speed level of the auxiliary blower 110 to become a maximum rotation speed level (S115). As a result, the flowability of a cold air or a hot air between the front seat region X and the rear seat region Y is maximized and the temperature difference between the front seat region X and the rear seat region Y is reduced. It is therefore possible to significantly improve the cooling or heating efficiency of the front seat region X and the rear seat region Y.

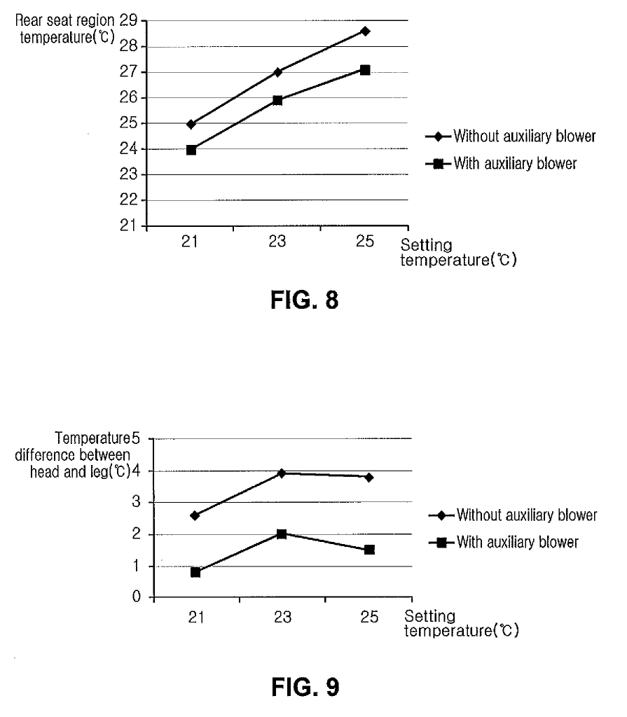

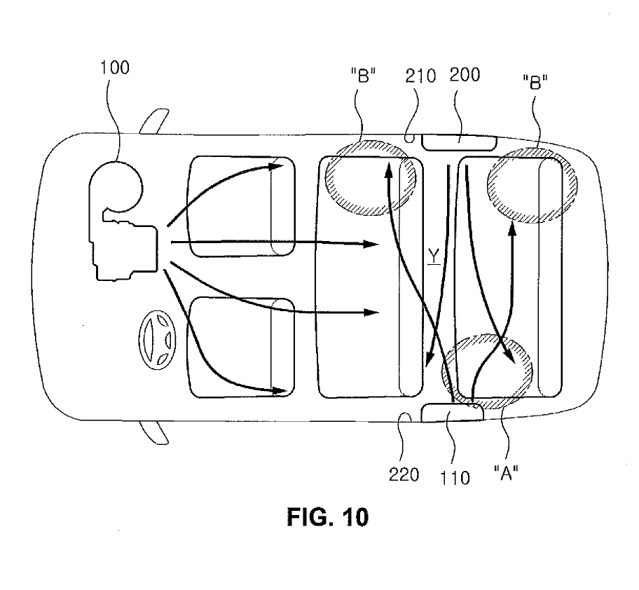

Next, the effects provided by the air conditioning system according to the first embodiment will be described with reference to FIGS. 8 and 9.

FIG. 8 is a graph indicating a temperature change in the rear seat region Y depending on the installation and non-installation of the auxiliary blower 110 when the front seat air conditioner 100 is automatically controlled. Temperatures were measured near the head of a passenger existing in the rear seat region Y.

When the temperatures of the front seat air conditioner 100 are set at 21° C., 23° C. and 25° C., the temperatures measured in the rear seat region Y were 25.0° C., 27.0° C. and 28.6° C. in case where the auxiliary blower 110 is not installed. In case where the auxiliary blower 110 is installed, the temperatures measured in the rear seat region Y were 24.0° C., 25.9° C. and 27.1° C.

Accordingly, it can be noted that, if the auxiliary blower 110 is installed, the temperature difference between the setting temperature of the front seat air conditioner 100 and the temperature of the rear seat region Y is significantly reduced. Thus, the temperature difference between the front seat region X and the rear seat region Y is reduced to a great extent.

As a result of the installation of the auxiliary blower 110, the flowability of an air existing within the vehicle room is improved and the cold air or the hot air supplied from the front seat air conditioner 100 is smoothly circulated through the rear seat region Y. It is therefore possible to reduce the temperature difference between the front seat region X and the rear seat region Y and to improve the comfort within the vehicle room.

FIG. 9 is a graph indicating a change of the temperature difference between the passenger head side and the passenger leg side in the rear seat region Y depending on the installation and non-installation of the auxiliary blower 110 when the front seat air conditioner 100 is automatically controlled. Temperature differences between the passenger head side and the passenger leg side in the rear seat region. Y were measured.

When the temperatures of the front seat air conditioner 100 are set at 21° C., 23° C. and 25° C., the temperature differences between the passenger head side and the passenger leg side in the rear seat region Y were 2.6° C., 3.9° C. and 3.8° C. in case where the auxiliary blower 110 is not installed. In case where the auxiliary blower 110 is installed, the temperature differences between the passenger head side and the passenger leg side in the rear seat region Y were 0.8° C., 2.0° C. and 1.5° C.

Accordingly, it can be noted that, if the auxiliary blower 110 is installed, the temperature difference between the passenger head side and the passenger leg side in the rear seat region Y is reduced.

As a result of the installation of the auxiliary blower 110, the flowability of an air existing within the vehicle room is improved and the cold air or the hot air is smoothly circulated through the passenger head side and the passenger leg side in the rear seat region Y. It is therefore possible to reduce the temperature difference between the passenger head side and the passenger leg side in the rear seat region Y and to improve the comfort in the rear seat region Y.

In conclusion, the installation of the auxiliary blower 110 makes it possible to reduce the temperature difference between the front seat region X and the rear seat region Y and to reduce the temperature difference between the upper side and the lower side in the rear seat region Y. It is therefore possible to significantly improve the comfort within the vehicle room.

### Second Embodiment

Next, an air conditioning system for motor vehicles including a front seat air conditioner and a rear seat air conditioner will be described as a second embodiment. Prior to describing features of the second embodiment, a rear seat air conditioner 200 will be briefly described with reference to FIG. 10.

The rear seat air conditioner 200 is installed in the rear seat region Y of the vehicle room. The rear seat air conditioner 200 supplies a cold air or a hot air to the rear seat region Y of the vehicle room, thereby cooling or heating the rear seat region Y of the vehicle room.

The rear seat air conditioner 200 is installed within one of vehicle sidewalls 210 and 220 which define the rear seat region Y. The rear seat air conditioner 200 is configured to supply a cold air or a hot air to the rear seat region Y of the vehicle room.

Next, certain features of the second embodiment will be described in detail with reference to FIGS. 10 to 14. Referring first to FIG. 10, the air conditioning system according to the second embodiment includes an auxiliary blower 110 installed at a position distant from the rear seat air conditioner 200. For example, the auxiliary blower 110 is installed in the vehicle sidewall 220 opposite to the rear seat air conditioner 200.

The auxiliary blower 110 installed at a position opposite to the rear seat air conditioner 200 is preferably configured to blow an air toward dead zones where a cold air or a hot air is hardly supplied from the rear seat air conditioner 200, namely the lateral regions of the rear seat air conditioner 200. In FIGS. 10 to 13, the dead zones, namely the lateral regions of the rear seat air conditioner 200, are designated by reference symbol “B”.

The auxiliary blower 110 installed at a position opposite to the rear seat air conditioner 200 serves to blow a cold air or a hot air toward the rear seat air conditioner 200 which supplies the cold air or the hot air. Thus, the auxiliary blower 110 serves to stir the cold air or the hot air supplied from the rear seat air conditioner 200. As a result, the cold air or the hot air supplied from the rear seat air conditioner 200 can be evenly and uniformly blown toward the individual seats of the rear seat region Y. This makes it possible to maintain a uniform temperature distribution in the rear seat region Y without generating a temperature difference between the respective seats. It is therefore possible to improve the cooling or heating efficiency in the rear seat region Y.

Furthermore, the auxiliary blower 110 is configured to blow an air toward the dead zones B where a cold air or a hot air is not supplied from the rear seat air conditioner 200. This enables the cold air or the hot air to flow from the rear seat air conditioner 200 toward the dead zones B.

This makes it possible to increase the cooling or heating efficiency in the dead zones B, thereby eliminating a temperature difference between the dead zones B and other regions. As a result, it is possible to realize a comfortable vehicle room environment while maintaining a uniform temperature distribution in the rear seat region Y without generating a temperature difference between the respective seats.

As is the case in the air conditioning system according to the first embodiment, the auxiliary blower 110 is controlled by a control unit (not shown) (see FIG. 6). Thus, the auxiliary blower 110 is actively controlled depending on the vehicle conditions. Specifically, the auxiliary blower 110 is actively controlled depending on the existence or non-existence of a passenger in the rear seat region Y, the vehicle travel speed, the vehicle room temperature and the rotation speed level of the main blower 138 of the front seat air conditioner 100.

The configuration of the control unit, the function of the control unit and the control of the auxiliary blower 110 using the control unit are the same as those of the first embodiment. Therefore, no description will be made thereon.

The auxiliary blower 110 of the air conditioning system according to the second embodiment may be actively controlled depending on the rotation speed level of a blow (not shown) of the rear seat air conditioner 200. The control of the auxiliary blower 110 depending on the rotation speed level of the blow of the rear seat air conditioner 200 is the same as the control of the auxiliary blower 110 depending on the rotation speed level of the main blower 138 of the front seat air conditioner 100. Therefore, no description will be made thereon.

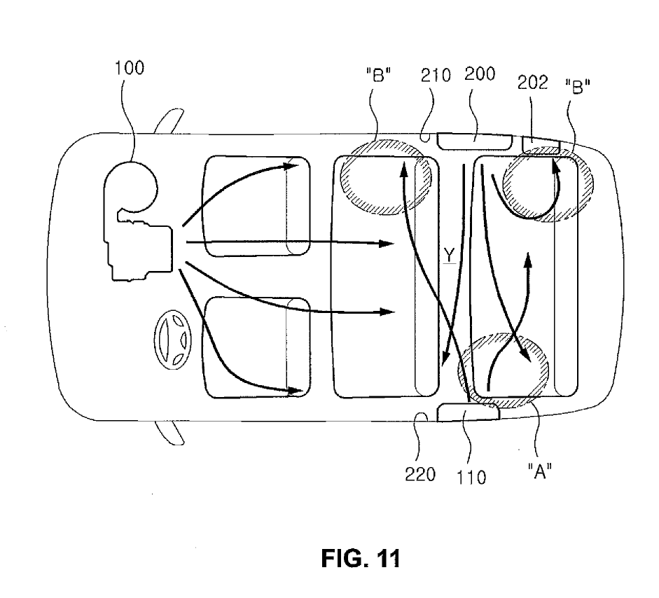

Next, an air conditioning system according to one modification of the second embodiment of the present invention will be described with reference to FIG. 11.

The air conditioning system according to this modification includes a rear seat air conditioner 200 which has an air intake port 202 disposed in at least one of the dead zones B where a cold air or a hot air is not supplied from the rear seat air conditioner 200.

When the rear seat air conditioner 200 and the auxiliary blower 110 are operated (turned on), the air intake port 202 of the rear seat air conditioner 200 draws an air existing in the dead zone B. Thus, a negative pressure is generated in the dead zone B. This enables an air to flow from other regions toward the dead zone B. Specifically, the cold air or the hot air ejected from the rear seat air conditioner 200 and the auxiliary blower 110 is allowed to flow toward the dead zone B and is drawn into the air intake port 202.

As a result, it is possible to increase the blowing efficiency of the cold air or the hot air blown toward the dead zone B. This helps eliminate a temperature difference between the dead zone B and the remaining regions. Accordingly, it is possible to realize a comfortable vehicle room environment while maintaining a uniform temperature distribution in the rear seat region Y without generating a temperature difference between the respective seats.

If the air intake port 202 of the rear seat air conditioner 200 is disposed in the dead zone B, the air ejected from the rear seat air conditioner 200 and the auxiliary blower 110 unidirectionally flows toward the dead zone B. Thus, the amount of the air blown toward the lateral region A of the auxiliary blower 110 may be reduced.

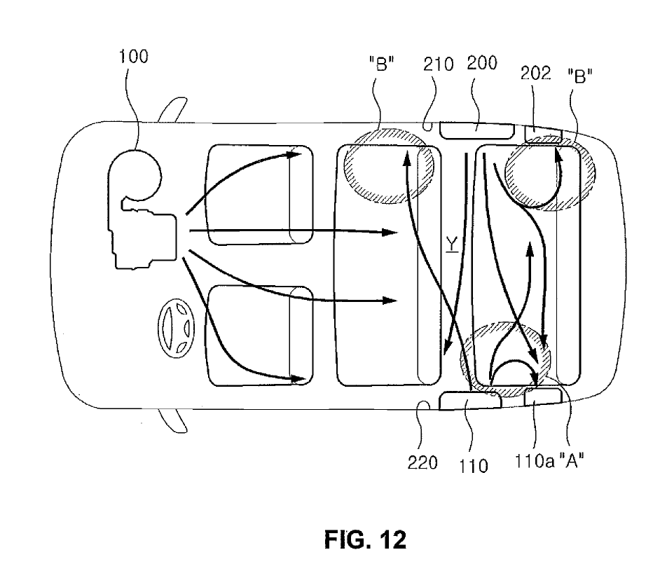

In view of this, as shown in FIG. 12, an air intake port 110a of the auxiliary blower 110 is disposed at one side of the auxiliary blower 110 so as to draw an air existing in the lateral region A of the auxiliary blower 110. Specifically, the air intake port 110a of the auxiliary blower 110 is disposed in the vehicle sidewall 220 opposite to the air intake port 202 of the rear seat air conditioner 200 so as to draw an air existing in the lateral region A of the auxiliary blower 110.

Thus, a negative pressure is generated in the lateral region A of the auxiliary blower 110. This makes it possible to increase the air flow efficiency in the lateral region A of the auxiliary blower 110 and to enhance the blowing efficiency of the cold air or the hot air blown toward the lateral region A of the auxiliary blower 110.

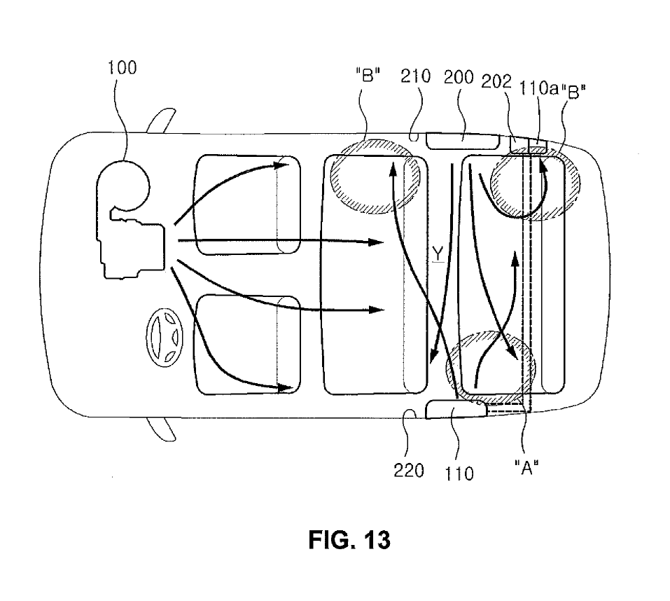

Next, an air conditioning system according to another modification of the second embodiment of the present invention will be described with reference to FIG. 13.

The air conditioning system according to this modification has a configuration in which, just like the air intake port 202, the air intake port 110a of the auxiliary blower 110 is also disposed in the dead zone B. Thus, the rear seat air conditioner 200 and the auxiliary blower 110 can draw an air through the air intake port 202 and the air intake port 110a arranged side by side in the dead zone B. As a result, a negative pressure is generated in the dead zone B. This enables an air existing in other regions to flow toward the dead zone B. It is therefore possible to increase the blowing efficiency of the cold air or the hot air blown toward the dead zone B.

Preferably, the air intake port 202 of the rear seat air conditioner 200 is one-piece formed with the air intake port 110a of the auxiliary blower 110.

In the air conditioning system according to the second embodiment of the present invention, the auxiliary blower 110 is installed in the rear seat region Y to enhance the stirring efficiency of the cold air or the hot air existing in the rear seat region Y. This makes sure that the cold air or the hot air ejected from the rear seat air conditioner is evenly and uniformly blown toward the respective seats of the rear seat region Y. It is therefore possible to maintain a uniform temperature distribution without generating a temperature difference between the respective seats of the rear seat region Y. As a result, it is possible to enhance the cooling or heating efficiency in the rear seat region Y and to significantly improve the comfort in the rear seat region Y.

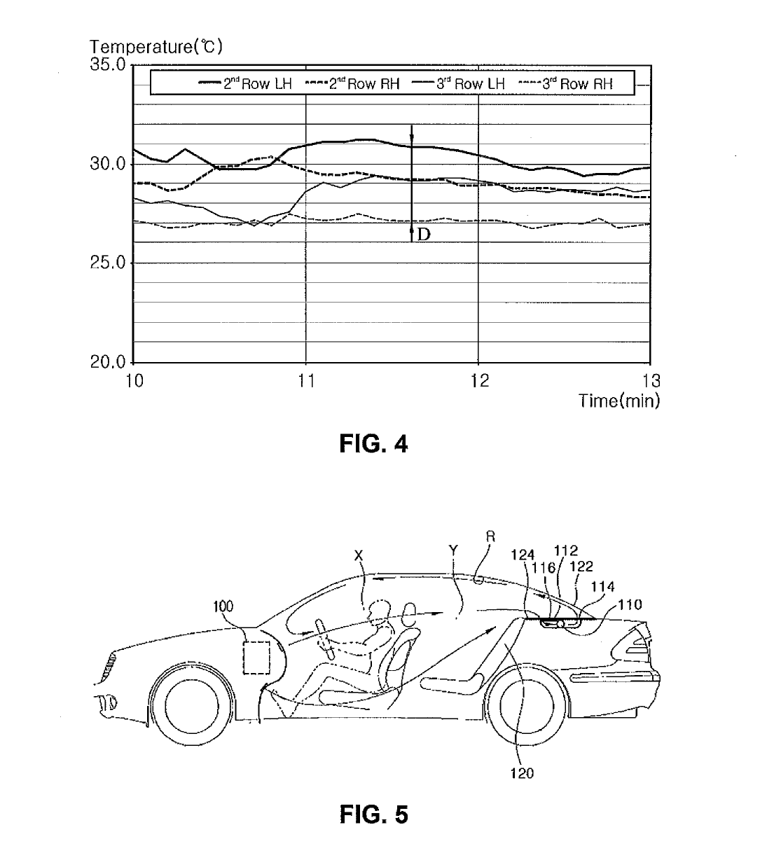

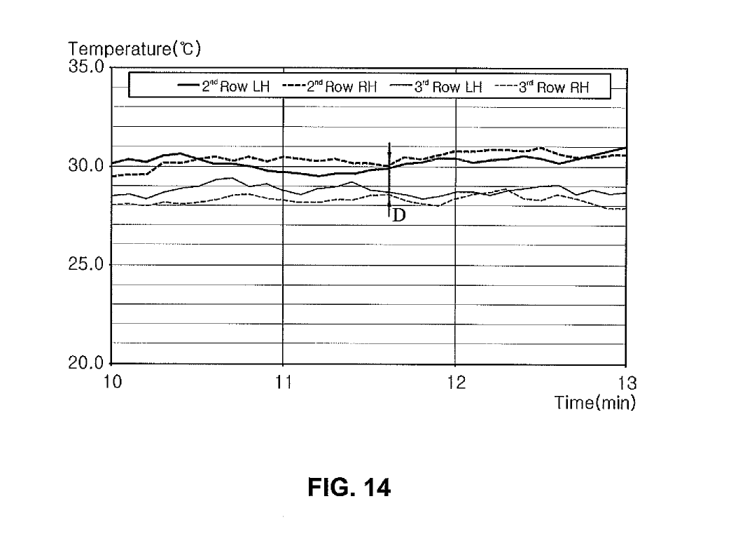

In order to see the operational effects provided by the auxiliary blower 110, the temperatures in the respective seats of the rear seat region Y were measured with the auxiliary blower 110 turned on. The result of measurement is shown in FIG. 14. As can be seen in FIG. 14, the temperature difference D between the left seat LH and the right seat RH of the second seat row and the left seat LH and the right seat RH of the third seat row is quite smaller than that of the prior art (see FIG. 4).

According to the present invention, the temperature difference between the respective seats of the rear seat region Y is significantly improved. It is therefore possible to enhance the cooling or heating efficiency in the rear seat region Y and to improve the comfort in the rear seat region Y.

While certain preferred embodiments of the invention have been described hereinabove, the present invention is not limited to these embodiments. It is to be understood that various changes and modifications may be made without departing from the scope of the invention defined in the claims.

1-21. (canceled)

22. An air conditioning system for motor vehicles, comprising:
a front seat air conditioner installed in a front seat region of a vehicle room; and
an auxiliary blower configured to draw an air existing in the vehicle room and blow the air into the vehicle room, wherein a first cold air or a first hot air supplied to the front seat region flows toward a rear seat region.

23. The air conditioning system of claim 22, wherein the auxiliary blower is installed in a rear covering shelf between the rear seat region and a rear glass and is configured to draw an air existing in the rear seat region and blow the air toward the front seat region along a roof of the vehicle room.

24. The air conditioning system of claim 23, wherein the auxiliary blower is embedded within the rear covering shelf, the auxiliary blower including an air intake port disposed to face toward the rear seat region and an air discharge port disposed to face the rear glass.

25. The air conditioning system of claim 24, wherein the auxiliary blower includes an intake grill installed in the air intake port, a discharge grill installed in the air discharge port, and a filter installed in the intake grill to remove foreign materials existing in the air existing in the vehicle room.

26. The air conditioning system of claim 22, wherein the auxiliary blower is formed of a cross flow fan.

27. The air conditioning system of claim 22, further comprising a rear seat air conditioner installed within one of a pair of vehicle sidewalls defining the rear seat region, the rear seat air conditioner configured to supply at least one of a second cold air and a second hot air to the rear seat region, wherein the auxiliary blower is configured to blow the air existing in the vehicle room toward the rear seat region to stir the at least one of the cold air and the hot air supplied from the rear seat air conditioner to the rear seat region.

28. The air conditioning system of claim 27, wherein the auxiliary blower is installed in the one of the pair of sidewalls opposite the rear seat air conditioner.

29. The air conditioning system of claim 28, wherein the auxiliary blower is configured to blow the air existing in the vehicle room toward a dead zone where the second cold air or the second hot air is not sufficiently supplied from the rear seat air conditioner.

30. The air conditioning system of claim 29, wherein the dead zone is a lateral region of the rear seat air conditioner, and the auxiliary blower is configured to blow the air existing in the vehicle room toward the lateral region of the rear seat air conditioner.

31. The air conditioning system of claim 29, wherein the rear seat air conditioner includes a first air intake port disposed to draw an air existing in the dead zone wherein a negative pressure is generated in the dead zone to allow the second cold air or the second hot air to flow from the auxiliary blower to the dead zone.

32. The air conditioning system of claim 31, wherein the auxiliary blower includes a second air intake port disposed at a position opposite the first air intake port of the rear seat air conditioner and configured to draw an air existing in a lateral region of the auxiliary blower opposite the first air intake port wherein the second cold air or the second hot air flows from the rear seat air conditioner toward the lateral region of the auxiliary blower.

33. The air conditioning system of claim 31, wherein the auxiliary blower includes a second air intake port formed in one piece with the first air intake port of the rear seat air conditioner so as to draw an air existing in the dead zone.

34. The air conditioning system of claim 22, further comprising a control unit for controlling the auxiliary blower, the control unit configured to turn off the auxiliary blower when a passenger does not exist in the rear seat region and turn on the auxiliary blower when a passenger exists in the rear seat region.

35. The air conditioning system of claim 34, wherein the control unit is configured to turn off the auxiliary blower if a main blower of the front seat air conditioner is operated at a maximum rotation speed level.

36. The air conditioning system of claim 35, wherein the control unit is configured to enter a first mode wherein the control unit controls the auxiliary blower depending on a temperature difference between two specific points within the vehicle room if a passenger exists in the rear seat region and if the main blower of the front seat air conditioner is operated at a rotation speed level lower than the maximum rotation speed level.

37. The air conditioning system of claim 36, wherein the control unit is configured to enter a second mode wherein the control unit variably controls a rotation speed level of the auxiliary blower depending on the temperature difference between two specific points if the temperature difference between two specific points is smaller than a predetermined reference temperature difference in the first mode, and the control unit is configured to enter a third mode wherein the control unit controls the auxiliary blower depending on a vehicle travel speed if the temperature difference between two specific points is equal to or larger than the predetermined reference temperature difference.

38. The air conditioning system of claim 37, wherein the control unit is configured to enter a fourth mode in which the control unit controls the rotation speed level of the auxiliary blower depending on the vehicle travel speed if the vehicle travel speed is a low vehicle speed lower than a predetermined reference vehicle speed in the third mode, and the control unit is configured to enter a fifth mode wherein the control unit controls the auxiliary blower to operate at the maximum rotation speed level if the vehicle travel speed is a high vehicle speed equal to or higher than the predetermined reference vehicle speed.

39. The air conditioning system of claim 37, wherein the temperature difference between two specific points within the vehicle room is a temperature difference between the front seat region where the cold air or the hot air is smoothly supplied from the front seat air conditioner and the rear seat region where the cold air or the hot air is poorly supplied from the front seat air conditioner.

40. The air conditioning system of claim 37, wherein the control unit is configured to, in the second mode, variably control the rotation speed level of the auxiliary blower depending on the temperature difference between two specific points, wherein the rotation speed level of the auxiliary blower increases as the temperature difference between two specific points increases.

41. The air conditioning system of claim 38, wherein the control unit is configured to, in the fourth mode, variably control the rotation speed level of the auxiliary blower depending on the vehicle travel speed, wherein the rotation speed level of the auxiliary blower decreases as the vehicle travel speed decreases.
